(19) United States
(12) Patent Application Publication
(10) Pub. No.: US 2022/0120583 A1
(43) Pub. Date: Apr. 21, 2022

(54) AN INFORMATION PRESENTATION METHOD AND APPARATUS

(71) Applicant: BEIJING DIDI INFINITY TECHNOLOGY AND DEVELOPMENT CO., LTD., Beijing (CN)

(72) Inventors: Beijia SUN, BEIJING (CN); Yongqiang JIA, BEIJING (CN); Kun WANG, BEIJING (CN)

(21) Appl. No.: 17/425,229

(22) PCT Filed: Apr. 19, 2019
(86) PCT No.: PCT/CN2019/083458

§ 371 Date: Jul. 22, 2021

(30) Foreign Application Priority Data
Jan. 25, 2019 (CN) 201910075098.X

(51) Int. Cl. G01C 21/36; G01C 21/34

(52) U.S. Cl. CPC G01C 21/3697; G01C 21/3438

(57) ABSTRACT

Methods, systems, and apparatus, including computer programs encoded on computer storage media, for presenting information related to movement of an object. One of the methods includes obtaining information about a current movement path of a target object, detecting an anomaly associated with the current movement path of the target object based at least in part on the obtained information, obtaining, responsive to the detecting of the anomaly, information about a historical movement path of the target object prior to detected anomaly, determining an updated movement path of the target object based at least in part on the historical movement path and a projected route for the target object, and providing the updated movement path for display in a user interface.

### CROSS REFERENCE TO RELATED APPLICATION

This application claims priority to and benefits of Chinese Patent Application No. CN201910075098.X, filed with the State Intellectual Property Office (SIPO) of the People's Republic of China on Jan. 25, 2019, and entitled “An Information Presentation Method and Apparatus.” The entirety of the aforementioned application is incorporated herein by reference.

### TECHNICAL FIELD

The disclosure relates generally to presenting information related to movement of an object.

### BACKGROUND

A ride-hailing platform can automatically connect users requesting transportation services (“service requesters”) with users providing transportation services (“service providers”). Each service requester or passenger may pay for using the transportation services, while each service provider or vehicle driver may receive compensation for providing the transportation services. After a passenger places an order for transportation service and the order has been accepted by a driver, a mobile application may allow the passenger to view, on a mobile device (e.g., a mobile phone), information about a movement path of the driver or the vehicle.

A real-time and continuous movement path of the driver or vehicle can reflect an actual movement state of the driver or vehicle. However, due to factors such as network instability, the passenger may obtain an incomplete real-time movement path of the driver or car or a movement path that does not change with time. In other words, the movement path of the driver, as obtained by the passenger, may lose its appearance of authenticity due to various external influences. This provides a technical problem calling for a technical solution that enables the display of a movement path of a driver with the appearance of continuity, instantaneity, and authenticity even when an anomaly occurs to obtained information about the movement path of the driver.

### SUMMARY

Various embodiments of the present disclosure can include systems, methods, and non-transitory computer readable media for presenting information related to movement of an object.

According to one aspect, a method for presenting information related to movement of an object may comprise obtaining information about a current movement path of a target object, detecting an anomaly associated with the current movement path of the target object based at least in part on the obtained information, obtaining, responsive to the detecting of the anomaly, information about a historical movement path of the target object prior to the detected anomaly, determining an updated movement path of the target object based at least in part on the historical movement path and a projected route for the target object, and providing the updated movement path for display in a user interface.

In some embodiments, the detecting an anomaly may comprise determining that the obtained information about the current movement path has not been updated or determining that the obtained information about the current movement path indicates that the target object is not moving on the projected route.

In some embodiments, the determining that the obtained information about the current movement path has not been updated may comprise determining that a most recent timestamp associated with the obtained information is identical to a most recent timestamp associated with information about a movement path of the target object obtained in a preceding instance.

In some embodiments, the method may further comprise determining that the anomaly has persisted for a pre-determined length of time, stopping determining the updated movement path of the target object, and providing, for display in the user interface, a notification indicating occurrence of the anomaly.

In some embodiments, the information about the current and historical movement paths of the target object may be obtained in a plurality of time periods, each having a preset duration. The time periods may comprise a current time period and a plurality of historical time periods.

In some embodiments, the determining an updated movement path may comprise determining speed information associated with the target object and a starting point associated with the target object in the current time period based on information about the historical movement path of the target object in at least one historical time period and determining the updated movement path based at least in part on the speed information, the starting point, and the projected route.

In some embodiments, the determining a starting point associated with the target object in the current time period may comprise determining an ending point associated with the target object in a historical time period preceding the current time period and setting the determined ending point as the starting point associated with the target object in the current time period.

In some embodiments, the determining speed information associated with the target object may comprise obtaining one or more preset speed thresholds associated with the target object, determining an average speed of the target object based on the information about the historical movement path of the target object in the at least one historical time period and determining the speed information based on the determined average speed and the obtained speed thresholds.

In some embodiments, the updated movement path of the target object may be determined based further on one or more distance thresholds associated with the movement of the target object.

In some embodiments, the updated movement path of the target object may be determined based further on one or more duration thresholds associated with the movement of the target object.

According to another aspect, a system for presenting information related to movement of an object may comprise a processor and a non-transitory computer-readable storage medium storing instructions executable by the processor to cause the system to perform operations comprising obtaining information about a current movement path of a target object, detecting an anomaly associated with the current movement path of the target object based at least in part on the obtained information, obtaining, responsive to the detecting of the anomaly, information about a historical movement path of the target object prior to the detected anomaly, determining an updated movement path of the target object based at least in part on the historical movement path and a projected route for the target object, and providing the updated movement path for display in a user interface.

According to another aspect, a non-transitory computer-readable storage medium for presenting information related to movement of an object may be configured with instructions executable by one or more processors to cause the one or more processors to perform operations comprising obtaining information about a current movement path of a target object, detecting an anomaly associated with the current movement path of the target object based at least in part on the obtained information, obtaining, responsive to the detecting of the anomaly, information about a historical movement path of the target object prior to the detected anomaly, determining an updated movement path of the target object based at least in part on the historical movement path and a projected route for the target object, and providing the updated movement path for display in a user interface.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Preferred and non-limiting embodiments of the invention may be more readily understood by referring to the accompanying drawings in which:

FIG. 1 illustrates an example network environment associated with an information presentation system.

FIG. 2 illustrates an example electronic device.

FIG. 3 illustrates an example method for determining and presenting information about a movement path of an object.

FIG. 4 illustrates an example method for determined a movement path of an object.

FIG. 5 illustrates an example method for determining a starting point associated with an object.

FIG. 6 illustrates an example method for determining speed information of an object.

FIG. 7 illustrates an example method for determining and presenting information related to movement of an object.

FIG. 8 illustrates a structural diagram of an example information presentation apparatus.

### DETAILED DESCRIPTION OF THE EMBODIMENTS

Specific, non-limiting embodiments of the present invention will now be described with reference to the drawings. Particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

Particular embodiments provide methods, systems, and apparatus, including computer programs encoded on computer storage media, for presenting information related to movement of an object. In some embodiments, a terminal associated with a user may display a movement path associated with an object. The movement path may be displayed in the context of an electronic map showing the locations of the object, the user, one or more landmarks, other suitable locations, or a combination thereof. In some embodiments, the object may be moving toward the location of the user or another destination associated with the user. The terminal may provide for display a projected route from the current location of the object to the destination. The projected route may be generated by a navigation service and be displayed on the electronic map. In some embodiments, the user may be a service requester or passenger for transportation services associated with a ride-hailing platform. The object may correspond to a driver or service provider accepting an order from the service requester or a vehicle of the service provider. The electronic map, movement path, or projected route may be generated by a terminal associated with the service requester, a terminal associated with the service provider, a server associated with the ride-hailing platform, another suitable system, or any combination thereof. As an example, data about movement of the vehicle may be gathered by the terminal associated with the service provider. Such data may be provided to the server associated with the ride-hailing platform or the terminal associated with the service requester, which may then generate a movement path associated with the service provider.

In some embodiments, one or more computing devices may determine that an anomaly has occurred to information obtained about the movement path of the object (e.g., the movement path information was not updated, the movement path information indicates that the object is not moving on a projected route). In some embodiments, in response to such a determination, the one or more computing devices may determine an updated movement path of the object based on a projected route for the object and information about a historical movement path of the object. The historical movement path may have been generated prior to the occurrence of the anomaly or when the object's movement path was normal. The updated movement path may be displayed on the terminal associated with the user and in the electronic map. In other words, when an accurate or up-to-date movement path of the object is not available, the terminal may simulate or generate a predictive movement path of the object and provide it for display. Particular embodiments may thereby create an appearance of continuity, instantaneity, and authenticity for the displayed movement path even when an anomaly occurs to obtained information about the movement path due to external influences. By presenting a movement path generated based on a combination of real-time data and historical data, particular embodiments may improve the efficiency of generating movement information, reduce the reliance on real-time data, and mitigate the impact of external factors (e.g., fluctuation of network connectivity) on the user experience.

Particular embodiments are described in the example scenario of ride-hailing services for illustration purposes. The terms “passenger” and “service requester” may be used interchangeably to refer to individuals, entities, or tools that request or order services. The terms “driver”, “service provider” and “user” may be used interchangeably to refer to individuals, entities, or tools that can provide services. Particular embodiments may be implemented in a plurality of other scenarios corresponding to other types of transportation. They may be implemented in other transportation environments such as land, sea, aviation, or any combination thereof. Vehicles may include taxis, private cars, cars for ride sharing services, buses, trains, bullet trains, high-speed railways, metros, ships, aircraft, spaceships, hot balloons, or self-driving cars, or any combination thereof. Particular embodiments may also be implemented in any service systems suitable to be used for presentation of a target object's movement path including, for example, a system for sending and/or receiving mail delivery. The application of the apparatus or method of this application may include web pages, plug-ins of browsers, customized systems, internal analysis systems, artificial intelligence robots, other suitable applications, or any combination thereof.

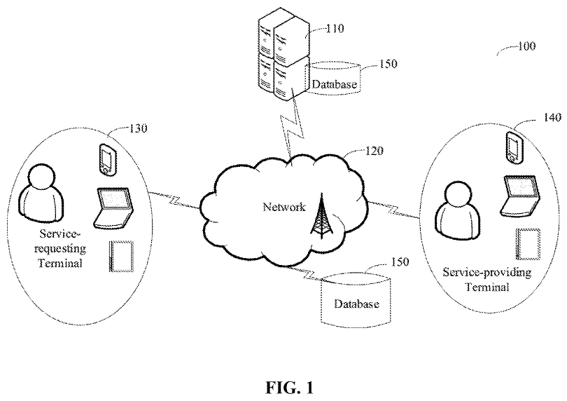

FIG. 1 illustrates an example network environment 100 associated with an information presentation system. The information presentation system may be used for transportation services including, for example, taxi service, driving service, fast-ride service, ride-sharing service, bus service, driver rental, shuttle service, other suitable transportation services, any combination thereof, or online platforms offers one or more of the transportation services. The information presentation system may include one or more of servers 110, networks 120, service-requesting terminals 130, service-providing terminals 140 and databases 150. The server 110 may include one or more processors that execute instructions.

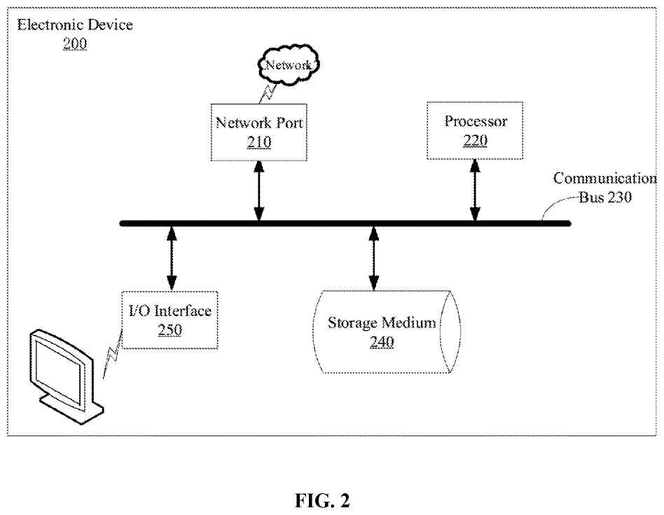

In some embodiments, the server 110 may be a single server or a server group. The server group may be centralized or distributed (e.g., the server 110 may be a distributed system). In some embodiments, the server 110 may be local or remote relative to a terminal. For example, the server 110 may access information and/or data stored in the service-requesting terminal 130, the service-providing terminal 140, the database 150, or any combination thereof via a network 120. In some embodiments, the server 110 may be implemented on a cloud platform. As an example, a cloud platform may comprise a private cloud, a public cloud, a mixed cloud, a community cloud, a distributed cloud, an inter-cloud, and multi-clouds, or any combination thereof. In some embodiments, the server 110 may be implemented on an electronic device 200 comprising one or more components shown in FIG. 2.

In some embodiments, the server 110 may comprise a processor 220. The processor 220 may process information and/or data related to a service request, so as to execute one or more functions described herein. In some embodiments, the processor may comprise one or more processing cores (e.g., a single-core processor (S) or a multi-core processor (S)). As an example, the processor can comprise Central Processing Unit (CPU), Application Specific Integrated Circuit (ASIC), Application Specific Instruction-set Processor (ASIP), Graphics Processing Unit (GPU), Physics Processing Unit (PPU), Digital Signal Processor (DSP), Field Programmable Gate Array (FPGA), Programmable Logic Device (PLD), controller, microcontroller unit, Reduced Instruction Set Computing (RISC), micro-processor, another suitable component, or any combination thereof.

The network 120 may be used for information or data exchange. In some embodiments, one or more components (e.g., server 110, service-requesting terminal 130, service-providing terminal 140, database 150) of the information presentation system may send information or data to other components. For example, the server 110 may obtain service requests from the service-requesting terminal 130 via the network 120.

In some embodiments, one or more components of the information presentation system (e.g., server 110, service-requesting terminal 130, service-providing terminal 140) may have access to the database 150. In some embodiments, when certain conditions are met, one or more components of the information presentation system may read or modify information associated with the service-requesting terminal 130, the service-providing terminal 140, public information, or any combination thereof. As an example and not by way of limitation, the server 110 may be enabled to read or modify the information of one or more users after receiving a service request. As another example and not by way of limitation, the service-providing terminal 140 can access information associated with a service requester when receiving a service request from the service-requesting terminal 130, but the service-providing terminal 140 may not be able to modify the information associated with the service-requesting terminal 130.

In some embodiments, information exchange among one or more components of the information presentation system can be achieved by requesting service. An object of the service request may be a movement path of a target object displayed.

FIG. 2 illustrates an example electronic device 200. The electronic device 200 may be used to implement the server 110, service-requesting terminal 130, or the service-providing terminal 140 as illustrated in FIG. 1. The electronic device 200 may comprise a processor 220 that may be used to execute functions disclosed herein. The electronic device 200 may be a computing device, such as a general computer or a computer with a special use, which may be used to implement the methods disclosed herein. Although FIG. 2 illustrates one electronic device 200, functions set forth herein may be implemented in a distributed manner on a plurality of similar platforms to distribute or balance processing load.

In some embodiments, the electronic device 200 may comprise a network port 210 connected to a network, one or more processors 220 for executing program instructions, a communication bus 230, and storage media 240. The storage media 240 may comprise a magnetic disk, ROM, RANI, another suitable storage medium, or any combination thereof. In some embodiments, a computer platform may further comprise program instructions stored in ROM, RANI, other types of non-transitory storage media, or any combination thereof. Methods according to particular embodiments disclosed herein may be implemented according to the program instructions. The electronic device 200 may further comprise an input/output (I/O) interface 250 between a computer and other input/output devices (for example, a keyboard, a monitor, and the like).

Although FIG. 2 illustrates only one processor 220, the electronic device 200 may comprise a plurality of processors. Any steps described in this disclosure that are executed by the one processor 220 may also be executed jointly or separately by a plurality of processors. For example, if the processor of the electronic device 200 executes Step A and Step B, it should be understood that Step A and Step B may be executed jointly by two different processors or separately by a single processor (e.g., a first processor executes Step A and a second processor executes Step B, the first processor and the second processor jointly execute Step A and Step B).

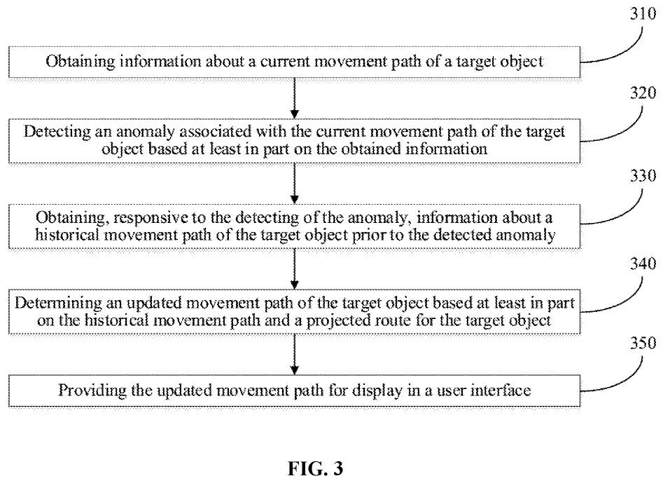

FIG. 3 illustrates an example method for determining and presenting information about a movement path of an object. The method may be performed on a mobile device or one or more other suitable computing devices associated with a service-requesting terminal. Alternatively, the method may be performed on one or more suitable computing devices associated with a server. For example, the server may be associated with a ride-hailing platform and be in connection with the service-requesting terminal. When an anomaly occurs to an obtained or displayed movement path of a target object (e.g., caused by external factors), the method may be applied to determine information about an updated movement path of the target object based on a current projected route of the target object and information about a historical movement path of the target object prior to the occurrence of the anomaly or when the obtained movement path was in a normal state. The updated movement path may then be presented on an electronic map displayed by the mobile device. Particular embodiments may improve the appearance of continuity, instantaneity, and authenticity of the movement path of a driver or a vehicle as perceived by a passenger or a service requester, when such movement path is displayed on a terminal associated with the passenger or service requester.

The method illustrated by FIG. 3 may begin at step 310, in which a computing device may obtain information about a current movement path of a target object. In a scenario associated with an online ride-hailing service, the target object may be a vehicle that can accept an order for transportation services. The information about a movement path may comprise information about a current location of the target object, time, an identifier of the target object, a current movement speed of the target object, other suitable information, or any combination thereof.

At step 320, the computing device may detect an anomaly associated with the current movement path of the target object based at least in part on the obtained information. In some embodiments, an anomaly may be detected if it is determined that the obtained information about the current movement path has not been updated. In other embodiments, an anomaly may be detected if it is determined that the obtained information about the current movement path indicates that the target object is not moving on the projected route. In yet other embodiments, when the computing device fails to receive information about the target object's movement path or if obtained movement information is void, the computing device may determine that the target object's movement path, as obtained, is abnormal.

In some embodiments, to determine whether the obtained information about the current movement path has been updated, the computing device may compare timestamps associated with currently obtained information with prior obtained information. Specifically, determining that the obtained information about the current movement path has not been updated may comprise determining that a most recent timestamp associated with the obtained information is identical to a most recent timestamp associated with information about a movement path of the target object obtained in a preceding instance. One or more other suitable methods may be used to determine whether the information about the current movement path has been updated.

At step 330, the computing device may obtain, responsive to the detecting of the anomaly, information about a historical movement path of the target object prior to the detected anomaly. The historical movement path may correspond to a time period prior to the occurrence of the anomaly or a time period in which the obtained movement path of the target object is in a normal state.

In some embodiments, the information about the current and historical movement paths of the target object may be obtained in a plurality of time periods. Each of the time periods may have a preset duration. The time periods comprise a current time period and a plurality of historical time periods. The duration of the time period may be set according to application scenarios. As an example and not by way of limitation, the duration may be preset to be short in order to facilitate high-precision representation of the target object's real-time movement path. In some embodiments, to obtain information about a current movement path of the target object, a computing device may obtain information about the movement path of the target object in the current time period. In some embodiments, to detect an anomaly associated with the current movement path of the target object, a computing device may detect an anomaly associated with obtained movement path in a current time period. Similarly, in some embodiments, to obtain information about a historical movement path of the target object, the computing device may obtain information about the movement path of the target object in one or more of the historical time periods. Here, the historical time periods may correspond to time periods in which the obtained movement path of the target object is in a normal state.

At step 340, the computing device may determine an updated movement path of the target object based at least in part on the historical movement path and a projected route for the target object.

The detected anomaly may indicate that the information about the current movement path information of the target object is not available or that though the information about the movement path of the object is obtained, it is in an abnormal state. In some embodiments, to maintain the appearance of continuity, authenticity, and instantaneity of a movement path shown to a passenger or service requester, it may be desirable to nonetheless display on the mobile device a movement path of the target object within a particular distance or a particular period of time. In some embodiments, to display the movement path of the target object on the mobile device, the computing device may determine a starting point of the target object in the current time period and speed information of the target object based on the information about the historical movement path of the target object before the occurrence of the anomaly. A movement path of the target object within a particular distance or a particular period of time may be displayed on the mobile device based on a portion of the projected route of the target object starting from the determined starting point of the target object.

In some embodiments, when the computing device obtains information about the movement path of the target object, it may determine whether a most recent timestamp of the current movement path information is the same as a most recent timestamp of movement path information obtained in a preceding instance. In some embodiments, if the two timestamps are identical, it indicates that the currently-obtained information about the target object's movement path is not up to date. In this case, the computing device may determine updated movement path information of the target object based on a current projected route of the target object and historical movement path information of the target object. In other embodiments, if the two timestamps are different, the computing device may determine, based on the obtained movement path information, whether the target object travels on the projected route of the target object. If the target object does not travel on the projected route and no new projected route is received, the computing device may determine updated movement path information of the target object based on the current projected route of the target object and the historical movement path information of the target object.

In some embodiments, the computing device may compare a current location of the target object with a projected path for the target object. If the received information about the movement path of the target object indicates that the target object is not moving on the projected path and the computing device has not received any new projected path for the target object, the computing device may determine that the obtained movement path of the target object is abnormal. Then, the computing device may determine information about an updated movement path for the target object based on a current projected route of the target object and information about a historical movement path of the target object while the movement of the target object as indicated by the historical movement path as normal. In some embodiments, if the received information about the movement path of the target object indicates that the target object is not moving on the projected route and the computing device has received a new projected route from a server (e.g., a server associated with a ride-hailing platform), the computing device may determine information about an updated movement path of the target object based on the obtained movement path information and the new projected route.

At step 350, the computing device may provide the updated movement path for display in a user interface. In some embodiments, the user interface may comprise a virtual map or electronic map showing an area associated with the target object. As an example, the area may encompass the locations of a service requester and a service provider in the scenario of a ride-hailing service. In some embodiments, the updated movement path may be displayed on the electronic map displayed in the user interface.

In some embodiments, before providing information about the updated movement path for display, the computing device may further obtain a network connection status of the computing device. If the current network connection status indicates that the computing device is connected to an appropriate network (e.g., the Internet) or in a normal connected state, the computing device may present the updated movement path in the user interface. Otherwise, if the computing device is not connected to the network, it may refrain from displaying the updated movement route and may display the target object as being still on the electronic map.

In some embodiments, the computing device may determine that the anomaly has persisted for a pre-determined length of time. It may then stop determining the updated movement path of the target object and provide, for display in the user interface, a notification indicating occurrence of the anomaly. In some embodiments, if the obtained movement path of the target object is continuously in an abnormal state for an extended period of time, the computing device may stop determining information about the updated movement path of the target object. Instead of displaying such an updated movement path, it may provide for display a notification indicating occurrence of the anomaly or indicating failure to obtain the location of the target object. The notification may be displayed after the time period for which the anomaly persists reaches or exceeds a threshold duration or a predetermined time period. The threshold duration may be set flexibly according to requirements of specific application scenarios. For example, the threshold duration may be set to 3 minutes. The notification indicating occurrence of the anomaly may comprise text such as, for example, “There is a delay in obtaining the location of the driver. Please wait for or contact the driver.”

In some embodiments, the notification indicating occurrence of the anomaly may be presented based on a maximum number of times for which the notification can be displayed or a minimum length of time for which the notification can be displayed. To prevent frequent display of notifications indicating occurrence of an anomaly or failure to obtain location of the target object, a maximum number of times for which the notification can be displayed may be set. For example, the maximum number of times for which the notification can be displayed may be set at two. To prevent flashing of the notification indicating occurrence of an anomaly or failure to obtain location of the target object, a minimum length of time for which the notification can be displayed may be set. For example, the minimum length of time for which the notification can be displayed may be set at three seconds. After display of the notification, if the computing device subsequently obtains correct information about the movement path of the target object, the notification may be removed from the user interface. The computing device may then display real-time information about the movement path of the target object.

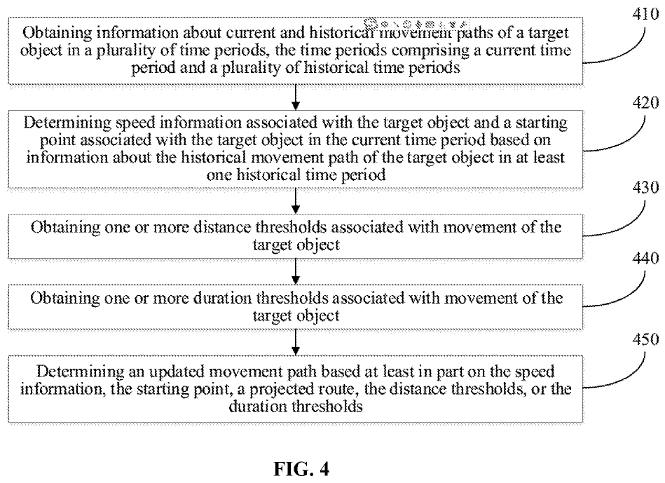

FIG. 4 illustrates an example method for determined a movement path of an object. The method may begin at step 410, in which the computing device may obtain information about current and historical movement paths of the target object in a plurality of time periods. Each time period may have a preset duration. The time periods may comprise a current time period and a plurality of historical time periods.

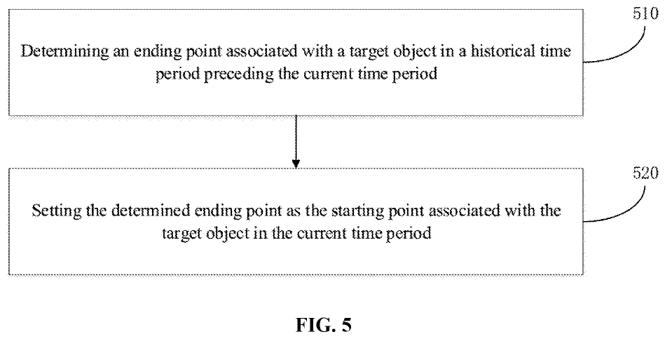

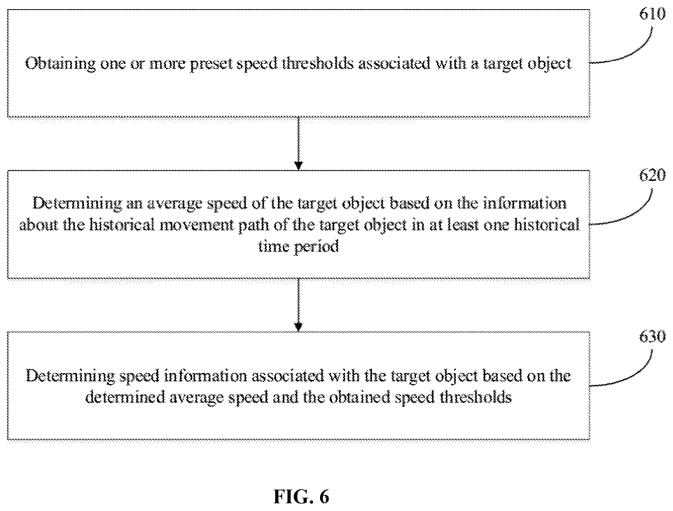

At step 420, the computing device may determine speed information associated with the target object and a starting point associated with the target object in the current time period based on information about the historical movement path of the target object in at least one historical time period. The computing device may determine the updated movement path based at least in part on the speed information, the starting point, and the projected route associated with the target object. In some embodiments, the starting point of the target object in a current time period may be determined based on an ending point of the target object in a preceding historical time period. In some embodiments, the speed information may be determined based on one or more speed thresholds associated with the target object and an average speed of the target object in one or more historical time periods. Example methods for determining the speed information and the starting point are at least illustrated by FIG. 5 and FIG. 6, which are described below.

At step 430, the computing device may obtain one or more distance thresholds associated with movement of the target object. In some embodiments, the updated movement path of the target object may be determined based further on one or more distance thresholds associated with the movement of the target object. The distance thresholds may comprise a maximum movement distance and a minimum distance for moving to a destination of the projected route. Such distance thresholds may be considered alongside one or more other factors such as the movement speed information associated with the target object, the starting point associated with the target object in the current time period, the projected route of the target object, another suitable factor, or any combination thereof.

In some embodiments, the computing device may determine the information about the updated movement path of the target object based on one or more of the movement distance thresholds. In some embodiments, the computing device may determine a movement distance based on information such as the movement distance thresholds. It may generate and display a movement path along the projected route, starting at the location corresponding to the starting point of the target object in the current time period, and having a length corresponding to the determined movement distance. This movement path may constitute the updated movement path in particular embodiments.

In some embodiments, the movement distance may be determined in one or more of a plurality of methods. As an example and not by way of limitation, to determine the movement distance, the computing device may first calculate a distance between the location of the starting point in the current time period and the location of a destination of the projected route (e.g., a location for picking up a passenger in an online ride-hailing service scenario) to obtain an estimated distance of arrival. If the estimated distance of arrival is greater than the minimum distance for movement to the destination of the projected route, the computing device may set the movement distance based on this distance threshold. The movement distance may be set such that it is smaller than the maximum movement distance and that after the target object moves by the set movement distance on the projected route, a distance from the target object to the destination of the projected route would not be smaller than the minimum distance for movement to the destination of the projected route.

At step 440, the computing device may obtain one or more duration thresholds associated with movement of the target object. In some embodiments, the updated movement path of the target object may be determined based further on one or more duration thresholds associated with the movement of the target object. The duration thresholds may comprise a maximum movement duration and a minimum duration for moving to a destination of the projected route. Such duration thresholds may be considered alongside one or more other factors such as the movement speed information associated with the target object, the starting point associated with the target object in the current time period, the projected route of the target object, another suitable factor, or any combination thereof.

In some embodiments, the computing device may determine the information about the updated movement path of the target object based on one or more of the movement duration thresholds. In some embodiments, the computing device may determine a movement distance based on information such as the movement duration thresholds. It may generate and display a movement path along the projected route, starting at the location corresponding to the starting point of the target object in the current time period, and having a length corresponding to the determined movement distance. This movement path may constitute the updated movement path in particular embodiments.

In some embodiments, the movement distance may be determined in one or more of a plurality of methods. As an example and not by way of limitation, to determine the movement distance, the computing device may first calculate a distance between the location of the starting point in the current time period and the location of a destination of the projected route (e.g., a location for picking up a passenger in an online ride-hailing service scenario) to obtain an estimated distance of arrival. Then, the computing device may determine an estimated time before arrival. If the estimated time of arrival is greater than the minimum duration for movement to the destination of the projected route, the computing device may set the movement distance based on this duration threshold. The movement distance may be set such that the time needed to move such distance is smaller than the maximum movement duration and that after the target object moves by the set movement distance on the projected route, a period of time it takes for the target object to move to the destination of the projected route would be greater than the minimum duration for movement to the destination of the projected route.

In some embodiments, the estimated distance of arrival and estimated time before arrival disclosed herein may be dynamically updated in real time based on locations and speeds of the target object. By using movement duration thresholds, movement distance thresholds, or speed thresholds to generate updated movement path of a target object, particular embodiments may enable display of the target object's movement path in a particular range of distance or time without impacting the appearance of authenticity of the displayed movement path.

FIG. 5 illustrates an example method for determining a starting point associated with an object. In some embodiments, the computing device may determine the starting point associated with the target object in a current time period, in which the obtained movement path of the target object is determined to be abnormal, based on information about a historical movement path of the target object in one or more historical time periods. The obtained movement path of the target object may be determined to be normal in the historical time periods. The method may begin at step 510, in which the computing device may determine an ending point associated with the target object in a historical time period preceding the current time period. At step 520, the computing device may set the determined ending point as the starting point associated with the target object in the current time period.

FIG. 6 illustrates an example method for determining speed information of an object. In some embodiments, the computing device may determine the speed information of the target object based on information about a historical movement path of the target object in one or more historical time periods prior to occurrence of the anomaly. The method may begin at step 610, in which the computing device may obtain one or more preset speed thresholds associated with the target object. The speed thresholds may comprise a maximum speed and a minimum speed. The speed thresholds may be flexibly set based on requirements of specific application scenarios. At step 620, the computing device may determine an average speed of the target object based on the information about the historical movement path of the target object in the at least one historical time period. The movement path information of the target object may be determined to be normal in the at least one historical time period. At step 630, the computing device may determine the speed information based on the determined average speed and the obtained speed thresholds.

In some embodiments, to determine the speed information based on the historical average speed and the speed thresholds, the computing device may apply weights to the historical average speed after it is obtained. For example, the computing device may multiply the obtained historical average speed by a predetermined weight, to obtain a target speed. Then, the computing device may determine whether the obtained target speed is between the maximum speed and the minimum speed. If so, the obtained target speed may be set as the movement speed information of the target object. Otherwise, the computing device may calculate a first absolute value of a difference between the target speed and the maximum speed and a second absolute value of a difference between the target speed and the minimum movement speed. If the first absolute value is smaller than the second absolute value, the maximum movement speed may be set as the target movement speed and used as the movement speed information. If the first absolute value is greater than the second absolute value, the minimum movement speed may be set as the target movement speed and used as the movement speed information.

In some embodiments, after the target speed is determined, it may be further adjusted. Specifically, the computing device may start from the starting point associated with the target object in the current time period and move forward three to six points. If there are less than three usable points, the computing device may set the target speed as the minimum speed.

In some embodiments, the computing device may determine the updated movement path of a target object further based on an updated projected route. In some embodiments, the obtained information about the current movement path of a target object may have been updated or be up to date. In this case, if the movement path information indicates that the target object is not moving on the projected route associated with the target object and the computing device has received a new projected route issued by a server, the computing device may use the following steps to determine the information about an updated movement path of the target object. The computing device may determine, based on the obtained movement path information, whether the target object is located on the new projected route. If the target object is moving on the new projected route, the computing device may determine the updated movement path based on the obtained movement path information and the new projected route and display the updated movement path that overlays the new projected route. In this case, the previous projected route may be removed from a user interface displayed by the computing device and replaced with the new projected route.

In some embodiments, the obtained information about the current movement path of a target object may have been updated or be up to date. The computing device may obtain a “current location” of the target object, which is the location of the target object as indicated by the movement path information prior to the update. In the case that the target object has not deviated from the projected route, the computing device may determine a distance between a most recent location of the target object as indicated by the updated movement path information and the destination of the projected route. If this distance is shorter than a distance between the obtained current location and the destination of the projected route, the computing device may determine the information about the updated movement path of the target object based on the preset minimum speed, the projected route of the target object, and the obtained current location.

In some embodiments, the obtained information about the current movement path of a target object may have been updated or be up to date. The computing device may obtain a “current location” of the target object, which is the location of the target object as indicated by the movement path information prior to the update. In the case that the target object has not deviated from the projected route, the computing device may determine a distance between a most recent location of the target object as indicated by the updated movement path information and the destination of the projected route. If this distance is longer than a distance between the obtained current location and the destination of the projected route, the computing device may determine the information about the updated movement path of the target object based on a preset time period to move from the most recent location to the current location, the projected route of the target object, and the obtained current location. The time period may be flexibly set based on requirements of specific application scenarios.

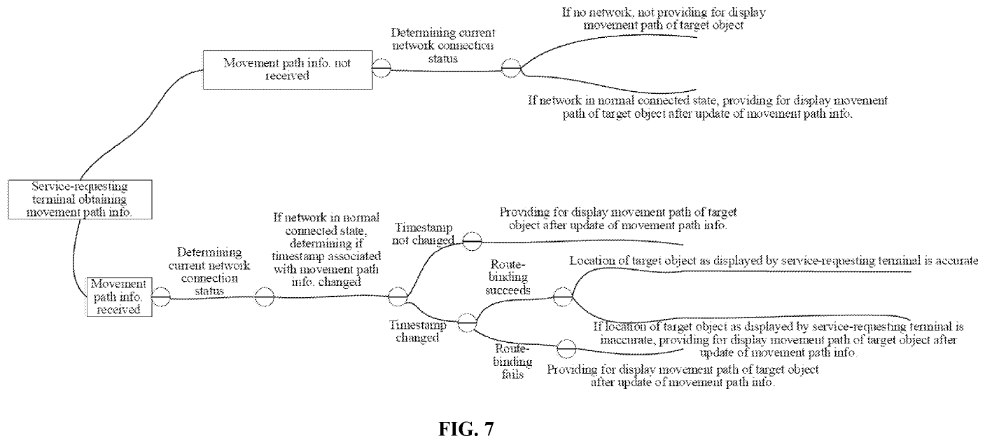

FIG. 7 illustrates an example method for determining and presenting information related to movement of an object. In some embodiments, a service-requesting terminal may request information about a movement path of a driver or a service provider. In some embodiments, if no feedback information is received or any received feedback information does not include movement path information, the service-requesting terminal may determine a current network connection status of the terminal. If the network connection is normal, the service-requesting terminal may determine information about an updated movement path of the target object based on a current projected route of the target object and information about a historical movement path of the target object, for which the target object was in a normal movement state. The service-requesting terminal may present the information about the updated movement path on an electronic map. If the network connection is abnormal, the service-providing terminal may refrain from presenting movement path information of the target object.

In some embodiments, if the service-requesting terminal does receive feedback information about a movement path of the driver or service provider, the service-requesting terminal may determine its current network connection status. If network connection is normal, the service-requesting terminal may determine a timestamp of the currently received movement path information and a timestamp of movement information received in a preceding instance. If the timestamps are identical, the passenger side may determine updated movement path information of the target object based on the current projected route of the target object and the historical movement path information of the target object, for which the target object was in a normal movement state. The service-requesting terminal may present the information about the updated movement path on an electronic map. If the timestamps are different, the service-requesting terminal may determine whether the target object is moving on the projected route. If the target object is not moving on the projected route (i.e., route-binding fails), the service-requesting terminal may determine that updated movement path information of the target object based on the current projected route of the target object and the historical movement path information of the target object and present the information about the updated movement path on the electronic map. If the target object is moving on the projected route (i.e., route-binding succeeds), the service-requesting terminal may determine whether a current location of the target object as indicated by the movement path information is the same as a location of the target object displayed on the service-requesting terminal. If not, the service-requesting terminal may determine updated movement path information of the target object based on the current location of the target object and the projected route of the target object.

In some embodiments, the methods disclosed herein may be executed on a mobile device associated with a passenger or a service-requesting terminal. In other embodiments, the methods disclosed herein may be executed on a server associated with a ride-hailing platform. Specifically, the server may determine information about a movement path of a target object that is displayed on a service-requesting terminal and send such information to the service-requesting terminal for display.

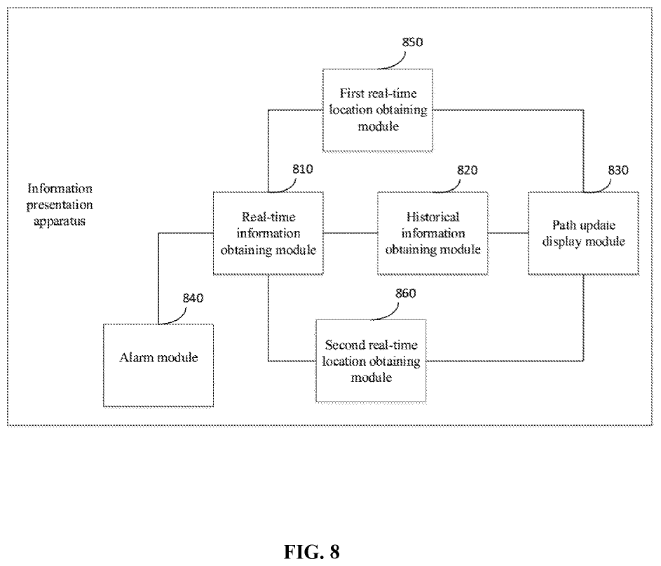

FIG. 8 illustrates a structural diagram of an example information presentation apparatus. The apparatus may be configured to execute one or more steps of the methods disclosed herein.

As illustrated by FIG. 8, the information presentation apparatus may comprise a real-time information obtaining module 810, configured to obtain movement path information of a target object; a historical information obtaining module 820, configured to obtain historical movement path information of the target object in a normal movement path state if a movement path of the target object is determined abnormal based on the movement path information; and a path update display module 830, configured to determine updated movement path information of the target object based on a current projected route of the target object and historical movement path information of the target object in a normal movement path state, and to present the updated movement path information on an electronic map.

In some embodiments, the real-time information obtaining module 810 may be specifically configured to obtain movement path information of the target object in a current time period. The historical information obtaining module 820 may be specifically configured to obtain historical movement path information of the target object in a historical time period, when the target object was in the normal movement path state, if a movement path of the target object in the current time period is determined to be abnormal based on the movement path information.

In some embodiments, the historical information obtaining module 820 may be specifically configured to determine that the movement path of the target object is abnormal when any of the following situations occurs: the path information of the target object is not updated; and the obtained movement path information indicates that the target object is not moving on the current projected route.

In some embodiments, the historical information obtaining module 820 may be specifically configured to determine that the path information of the target object is not updated when a most recent timestamp of the obtained movement path information is identical to a most recent timestamp of movement path information obtained in a preceding instance.

In some embodiments, the movement path information presentation apparatus further comprises an alarm module 840, configured to stop the determination of the updated movement path information and to present a notification indicating occurrence of an anomaly if the movement path of the target object is constantly in an abnormal state for a predetermined period of time.

In some embodiments, the alarm module 840 may be specifically configured to present the notification indicating occurrence of the anomaly based on a threshold number of times for which the notification can be displayed and a threshold length of time for which the notification can be displayed.

In some embodiments, the path update display module 830 may be specifically configured to obtain a current network connection status and to present the updated movement path information on the electronic map if the current network connection status is a normal connected state.

In some embodiments, the path update display module 830 may be specifically configured to determine movement speed information and movement starting point information of the target object in a current time period based on historical movement path information of the target object in a historical time period, when the target object was in the normal movement path state, and to determine the updated movement path information of the target object based on the movement speed information, the movement starting point information in the current time period, and the projected route of the target object.

In some embodiments, the path update display module 830 may be specifically configured to determine movement ending point information in movement path information of the target object in a most recent historical time period when the target object was in the normal movement path state and use the movement ending point information as the movement starting point information of the target object in the current time period.

In some embodiments, the path update display module 830 may be specifically configured to obtain one or more preset speed thresholds, to determine a historical average movement speed of the target object based on the historical movement path information of the target object in the historical time period when the target object was in the normal movement path state, and to determine the movement speed information of the target object based on the determined historical average movement speed and the obtained speed thresholds.

In some embodiments, the speed thresholds may comprise a maximum movement speed and a minimum movement speed.

In some embodiments, the path update display module 830 may be specifically configured to obtain one or more preset movement distance thresholds and to determine the updated movement path information of the target object based on the one or more movement distance thresholds, the movement speed information, the movement starting point information in the current time period, and the projected route of the target object.

In some embodiments, the movement distance thresholds may comprise a maximum movement distance and a minimum distance for moving to a destination of the projected route.

In some embodiments, the path update display module 830 may be specifically configured to obtain one or more preset movement duration thresholds and to determine the updated movement path information of the target object based on the one or more movement duration thresholds, the movement speed information, the movement starting point information in the current time period, and the projected route of the target object.

In some embodiments, the movement duration thresholds may comprise a maximum movement duration and a minimum duration for moving to a destination of the projected route.

In some embodiments, the movement path information presentation apparatus may further comprise a first real-time location obtaining module 850, configured to obtain a current location before the currently displayed movement path information is updated. The path update display module 830 may be further configured to determine, if a distance between a most recent location in the obtained movement path information and a destination of the projected route is smaller than a distance between the current location and the destination of the projected route, the updated movement path information of the target object based on a preset minimum movement speed, the projected route of the target object, and the obtained current location.

In some embodiments, the movement path information presentation apparatus may further comprise a second real-time location obtaining module 860, configured to obtain a current location before the currently displayed movement path information is updated. The path update display module 830 may be further configured to determine, if a distance between a most recent location in the obtained movement path information and a destination of the projected route is greater than a distance between the current location and the destination of the projected route, the updated movement path information of the target object based on a preset duration it takes to move from the most recent location to the current location, the projected route of the target object and the obtained current location.

One of ordinary skill in the art can understand details about the operation and processes of the system and apparatus described above by referring to corresponding processes in the method embodiments described above. In some embodiments, the division of the modules may be logical or functional. Alternative methods of division may be used. Multiple modules or components may be combined or integrated into another system. Some features may be omitted or not executed. The mutual coupling, direct coupling, or communication connection that is illustrated or discussed may be replaced by indirect coupling or communication connection through suitable communication interfaces, apparatuses, or modules, which may be electrical, mechanical, or in other suitable forms.

The modules described above as separate components may or may not be physically separated. The components illustrated as modules above may or may not be physical units, i.e., they can be located at one geographic location or distributed over a plurality of network units. The objectives of some embodiments can be achieved by selecting some or all units thereof as needed. The functional units disclosed herein may be integrated into one processing unit or may exist as independent physical units. Two or more units may be integrated into one unit.

In some embodiments, the aforementioned modules may be connected in a wired manner or a wireless manner for mutual connection or communication. The wired connection can comprise metal cables, optical cables, mixed cables, another suitable wired connection, or any combination thereof. The wireless connection can comprise connections in the form of LAN, WAN, Bluetooth, ZigBee, NFC, another suitable wireless connection, or any combination thereof. Two or more modules may be combined into one single module. Any module may be divided into two or more units.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for presenting information related to movement of an object, comprising:
obtaining information about a current movement path of a target object;
detecting an anomaly associated with the current movement path of the target object based at least in part on the obtained information;
obtaining, responsive to the detecting of the anomaly, information about a historical movement path of the target object prior to the detected anomaly;
determining an updated movement path of the target object based at least in part on the historical movement path and a projected route for the target object; and
providing the updated movement path for display in a user interface.

2. The method of claim 1, wherein the detecting an anomaly comprises:
determining that the obtained information about the current movement path has not been updated; or
determining that the obtained information about the current movement path indicates that the target object is not moving on the projected route.

3. The method of claim 2, wherein the determining that the obtained information about the current movement path has not been updated comprises:
determining that a most recent timestamp associated with the obtained information is identical to a most recent timestamp associated with information about a movement path of the target object obtained in a preceding instance.

4. The method of claim 1, further comprising:
determining that the anomaly has persisted for a pre-determined length of time;
stopping determining the updated movement path of the target object; and
providing, for display in the user interface, a notification indicating occurrence of the anomaly.

5. The method of claim 1, wherein:
the information about the current and historical movement paths of the target object is obtained in a plurality of time periods, each having a preset duration; and
the time periods comprise a current time period and a plurality of historical time periods.

6. The method of claim 5, wherein the determining an updated movement path comprises:
determining speed information associated with the target object and a starting point associated with the target object in the current time period based on information about the historical movement path of the target object in at least one historical time period; and
determining the updated movement path based at least in part on the speed information, the starting point, and the projected route.

7. The method of claim 6, wherein the determining a starting point associated with the target object in the current time period comprises:
determining an ending point associated with the target object in a historical time period preceding the current time period; and
setting the determined ending point as the starting point associated with the target object in the current time period.

8. The method of claim 6, wherein the determining speed information associated with the target object comprises:
obtaining one or more preset speed thresholds associated with the target object;
determining an average speed of the target object based on the information about the historical movement path of the target object in the at least one historical time period; and
determining the speed information based on the determined average speed and the obtained speed thresholds.

9. The method of claim 1, wherein the updated movement path of the target object is further determined based on one or more distance thresholds associated with the movement of the target object.

10. The method of claim 1, wherein the updated movement path of the target object is further determined based on one or more duration thresholds associated with the movement of the target object.

11. A system for presenting information related to movement of an object, comprising a processor and a non-transitory computer-readable storage medium storing instructions executable by the processor to cause the system to perform operations comprising:
obtaining information about a current movement path of a target object;
detecting an anomaly associated with the current movement path of the target object based at least in part on the obtained information;
obtaining, responsive to the detecting of the anomaly, information about a historical movement path of the target object prior to the detected anomaly;
determining an updated movement path of the target object based at least in part on the historical movement path and a projected route for the target object; and
providing the updated movement path for display in a user interface.

12. The system of claim 11, wherein the detecting an anomaly comprises:
determining that the obtained information about the current movement path has not been updated; or
determining that the obtained information about the current movement path indicates that the target object is not moving on the projected route.

13. The system of claim 12, wherein the determining that the obtained information about the current movement path has not been updated comprises:
determining that a most recent timestamp associated with the obtained information is identical to a most recent timestamp associated with information about a movement path of the target object obtained in a preceding instance.

14. The system of claim 11, wherein the operations further comprise:
determining that the anomaly has persisted for a pre-determined length of time;
stopping determining the updated movement path of the target object; and
providing, for display in the user interface, a notification indicating occurrence of the anomaly.

15. The system of claim 11, wherein:
the information about the current and historical movement paths of the target object is obtained in a plurality of time periods, each having a preset duration; and
the time periods comprise a current time period and a plurality of historical time periods.

16. The system of claim 15, wherein the determining an updated movement path comprises:
determining speed information associated with the target object and a starting point associated with the target object in the current time period based on information about the historical movement path of the target object in at least one historical time period; and
determining the updated movement path based at least in part on the speed information, the starting point, and the projected route.

17. The system of claim 16, wherein the determining a starting point associated with the target object in the current time period comprises:
determining an ending point associated with the target object in a historical time period preceding the current time period; and
setting the determined ending point as the starting point associated with the target object in the current time period.

18. The system of claim 16, wherein the determining speed information associated with the target object comprises:
obtaining one or more preset speed thresholds associated with the target object;
determining an average speed of the target object based on the information about the historical movement path of the target object in the at least one historical time period; and
determining the speed information based on the determined average speed and the obtained speed thresholds.

19. The system of claim 11, wherein the updated movement path of the target object is further determined based on one or more distance thresholds associated with the movement of the target object.

20. A non-transitory computer-readable storage medium for presenting information related to movement of an object, configured with instructions executable by one or more processors to cause the one or more processors to perform operations comprising:
obtaining information about a current movement path of a target object;
detecting an anomaly associated with the current movement path of the target object based at least in part on the obtained information;
obtaining, responsive to the detecting of the anomaly, information about a historical movement path of the target object prior to the detected anomaly;
determining an updated movement path of the target object based at least in part on the historical movement path and a projected route for the target object; and
providing the updated movement path for display in a user interface.
